(19) United States
(12) Patent Application Publication
(10) Pub. No.: US 2023/0319944 A1
(43) Pub. Date: Oct. 5, 2023

(54) ACCESS POINT APPARATUS, STATION APPARATUS, AND COMMUNICATION METHOD

(71) Applicant: Sharp Kabushiki Kaisha, Sakai City, Osaka (JP)

(72) Inventors: Hiromichi TOMEBA, Sakai City (JP); Yasuhiro HAMAGUCHI, Sakai City (JP); Atsushi SHIRAKAWA, Sakai City (JP)

(21) Appl. No.: 18/013,582

(22) PCT Filed: Jun. 28, 2021
(86) PCT No.: PCT/JP2021/024384

§ 371 Date: Dec. 29, 2022

(30) Foreign Application Priority Data
Jul. 1, 2020 (JP) 2020-113675

(51) Int. Cl. H04W 76/25; H04W 72/23

(52) U.S. Cl. CPC H04W 76/25; H04W 72/23; H04W 84/12

(57) ABSTRACT

An access point apparatus is an access point apparatus that maintains multiple connections, and includes a receiver that performs carrier sensing in the multiple connections and a transmitter that transmits a first frame for reserving a radio medium in a predetermined time interval in the multiple connections based on the carrier sensing, and the first frame includes information indicating a station apparatus having preference for use with respect to each of the multiple connections.

### TECHNICAL FIELD

The present invention relates to an access point apparatus, a station apparatus, and a communication method.

This application claims priority to JP 2020-113675 filed on Jul. 1, 2020, the contents of which are incorporated herein by reference.

### BACKGROUND ART

The specification of IEEE 802.11ax for realizing even higher speeds than with IEEE 802.11, which is a wireless Local Area Network (LAN) standard, have been standardized by the Institute of Electrical and Electronics Engineers Inc. (IEEE), and wireless LAN devices conforming to the specification draft have emerged on the market. Activities for standardizing IEEE 802.11be as a standard subsequent to IEEE 802.11ax have been started in recent days. As wireless LAN devices are rapidly widely used, studies are in progress, in standardizing IEEE 802.11be, to further improve a throughput per user in environments where wireless LAN devices are densely located.

In a wireless LAN, frames can be transmitted using unlicensed bands that enable wireless communication without permission (license) from a country or a region. The unlicensed bands that are widely used at present include the 2.4 GHz band and 5 GHz band. While the 2.4 GHz band has a relatively wide coverage, it is greatly affected by interference between communication apparatuses and cannot have a wide communication bandwidth. On the other hand, while the 5 GHz band has a wide communication band, it does not have a wide coverage. For those reasons, the frequency bands to be used need to be switched appropriately in order to implement a variety of service applications on a wireless LAN. However, the existing wireless LAN devices are required to disconnect the current connection first in order to switch the frequency band used for the communication.

For this reason, a multi-link operation (MLO) that enables a communication apparatus to maintain multiple connections (links) has been discussed in standardizing IEEE 802.11be (see NPL 1). According to the MLO, a communication apparatus can maintain multiple connections having different radio resources to be used and communication configurations. That is, the communication apparatus can simultaneously maintain connections in different frequency bands by using the MLO, and thus can change the frequency band for transmitting frames without performing a reconnection operation.

### CITATION LIST

### Non Patent Literature

NPL 1: IEEE 802.11-20/0115-4, Jan. 2020

### SUMMARY OF INVENTION

### Technical Problem

However, using the MLO means that a target communication area is widened. Thus, in an environment dense with terminals in which there are a large number of communication apparatuses, the influence of surrounding interference is not negligible, and communication efficiency in the unlicensed bands would not be improved simply by increasing the number of connections.

An aspect of the present invention has been made in view of the problems described above, and an object of the present invention is to disclose an access point apparatus, a station apparatus, and a communication method that improve communication efficiency using multiple connections in an environment dense with terminals in which there are a large number of communication apparatuses.

### Solution to Problem

An access point apparatus, a station apparatus, and a communication method according to an aspect of the present invention for solving the aforementioned problems are as follows.
(1) That is, an access point apparatus according to an aspect of the present invention is an access point apparatus that maintains multiple connections, and includes a receiver that performs carrier sensing in the multiple connections and a transmitter that transmits a first frame for reserving a radio medium in a predetermined time interval in the multiple connections based on the carrier sensing, the first frame including information indicating a station apparatus having preference for use with respect to each of the multiple connections.
(2) In addition, in the station apparatus according to an aspect of the present invention as described above in (1), the first frame may include information for soliciting a response frame for each of the multiple connections.
(3) In addition, in the station apparatus according to an aspect of the present invention as described above in (1), the first frame may include information indicating a connection among the multiple connections, the connection for which a station apparatus having preference for use is not configured.
(4) In addition, in the station apparatus according to an aspect of the present invention as described above in (1), the first frame may be an RTS frame that can be interpreted by a communication apparatus conforming to a communication standard other than a communication standard that the access point apparatus conforms to.
(5) In addition, in the station apparatus according to an aspect of the present invention as described above in (1), the first frame may include information indicating multiple station apparatuses that can preferentially use one connection among the multiple connections.
(6) In addition, a station apparatus according to an aspect of the present invention is a station apparatus that maintains multiple connections, including a receiver that receives a first frame for reserving a radio medium for a predetermined time interval in the multiple connections, and a transmitter that transmits a response frame for the first frame in the multiple connections in which the first frame has been received, the first frame including information indicating a station apparatus having preference for use with respect to each of the multiple connections, and the transmitter transmitting the response frame and further transmitting a transmission frame in at least one of the multiple connections that the station apparatus itself can preferentially use as indicated by the information indicating a station apparatus having preference for use after the predetermined time interval elapses.
(7) In addition, a communication method according to an aspect of the present invention is a communication method of an access point apparatus that maintains multiple connections, including steps of performing carrier sensing in the multiple connections and transmitting a first frame for reserving a radio medium in a predetermined time interval in the multiple connections based on the carrier sensing, and the first frame includes information indicating a station apparatus having preference for use with respect to each of the multiple connections.

### Advantageous Effects of Invention

According to one aspect of the present invention, communication efficiency can be improved by using multiple connections in an environment dense with terminals in which there are a large number of communication apparatuses, and thus the present invention contributes to improvement in user throughput of wireless LAN devices.

### BRIEF DESCRIPTION OF DRAWINGS

FIG. 1 is a diagram illustrating an example of a frame configuration according to an aspect of the present invention.

FIG. 2 is a diagram illustrating an example of a frame configuration according to an aspect of the present invention.

FIG. 3 is a diagram illustrating an example of communication according to an aspect of the present invention.

FIG. 4 is a schematic diagram illustrating examples of splitting a radio medium according to an aspect of the present invention.

FIG. 5 is a diagram illustrating a configuration example of a communication system according to an aspect of the present invention.

FIG. 6 is a block diagram illustrating a configuration example of a wireless communication apparatus according to an aspect of the present invention.

FIG. 7 is a block diagram illustrating a configuration example of a wireless communication apparatus according to an aspect of the present invention.

FIG. 8 is a schematic diagram illustrating an example of a coding scheme according to an aspect of the present invention.

FIG. 9 is a diagram illustrating an example of communication according to an aspect of the present invention.

FIG. 10 is a diagram illustrating an example of communication according to an aspect of the present invention.

FIG. 11 is a diagram illustrating an example of communication according to an aspect of the present invention.

FIG. 12 is a diagram illustrating an example of communication according to an aspect of the present invention.

FIG. 13 is a diagram illustrating an example of communication according to an aspect of the present invention.

FIG. 14 is a diagram illustrating an example of communication according to an aspect of the present invention.

### DESCRIPTION OF EMBODIMENTS

A communication system according to the present embodiment includes a wireless transmission apparatus (an access point apparatus or a base station apparatus that is an access point or a base station apparatus) and multiple wireless reception apparatuses (station apparatuses and terminal apparatuses that are stations and terminal apparatuses). In addition, a network including the base station apparatuses and terminal apparatuses is called a basic service set (BSS or a control range). In addition, the station apparatus according to the present embodiment can have functions of the access point apparatus. Similarly, the access point apparatus according to the present embodiment can have functions of the station apparatus. Therefore, in a case that a communication apparatus is simply mentioned below, the communication apparatus can indicate both the station apparatus and the access point apparatus.

The base station apparatus and the terminal apparatus in the BSS are assumed to perform communication based on Carrier sense multiple access with collision avoidance (CSMA/CA). Although the present embodiment is intended for an infrastructure mode in which a base station apparatus performs communication with multiple terminal apparatuses, the method of the present embodiment can also be performed in an ad hoc mode in which terminal apparatuses perform communication directly with each other. In the ad hoc mode, the terminal apparatuses substitute the base station apparatus to form a BSS. The BSS in the ad hoc mode will also be referred to as an independent basic service set (IBSS). In the following description, a terminal apparatus that forms an IBSS in the ad hoc mode can also be considered to be a base station apparatus.

In an IEEE 802.11 system, each apparatus can transmit transmission frames of multiple frame types in a common frame format. Each of transmission frames is defined as a physical (PHY) layer, a medium access control (MAC) layer, and a logical link control (LLC) layer.

A transmission frame of the PHY layer will be referred to as a physical protocol data unit (PPDU, PHY protocol data unit, or physical layer frame). The PPDU includes a physical layer header (PHY header) including header information and the like for performing signal processing in the physical layer, a physical service data unit (PSDU, PHY service data unit, or MAC layer frame) that is a data unit processed in the physical layer, and the like. The PSDU can include an aggregated MAC protocol data unit (MPDU) (A-MPDU) in which multiple MPDUs serving as retransmission units in a wireless section are aggregated.

The PPDU is modulated in accordance with the corresponding standard. In the IEEE 802.11n standard, for example, the PPDU is modulated into an orthogonal frequency division multiplexing (OFDM) signal.

A PHY header includes a reference signal such as a short training field (STF) used for detection, synchronization, and the like of signals, a long training field (LTF) used for obtaining channel information for demodulating data, and the like and a control signal such as a signal (SIG) including control information for demodulating data. In addition, STFs are classified into a legacy-STF (L-STF), a high throughput-STF (HT-STF), a very high throughput-STF (VHT-STF), a high efficiency-STF (HE-STF), an extremely high throughput-STF (EHT-STF), and the like in accordance with corresponding standards, and LTFs and SIGs are also similarly classified into an L-LTF, an HT-LTF, a VHT-LTF, an HE-LTF, an L-SIG, an HT-SIG, a VHT-SIG, an HE-SIG, and an EHT-SIG depending on the corresponding standards. The VHT-SIG is further classified into VHT-SIG-A1, VHT-SIG-A2, and VHT-SIG-B. Similarly, the HE-SIG is classified into HE-SIG-A1 to 4 and HE-SIG-B. In addition, on the assumption of technology update in the same standard, a universal SIGNAL (U-SIG) field including additional control information can be included.

The SIG can include, as information for demodulating received frames, information indicating a modulation scheme and a coding rate (MCS), the number of spatial data multiplexes (the number of layers), the number of spatial multiplexing users, information indicating the presence or absence of time-space coding (e.g., information indicating the presence or absence of time-space coding transmission diversity), information indicating the destination of the frame, information associated with a frame length of the frame (TXOP, etc.), and the like.

Furthermore, the PHY header can include information for identifying a BSS of a transmission source of the transmission frame (hereinafter, also referred to as BSS identification information). The information for identifying a BSS can be, for example, a service set identifier (SSID) of the BSS or a MAC address of a base station apparatus of the BSS. In addition, the information for identifying a BSS can be a value unique to the BSS (e.g., a BSS color, etc.) other than an SSID or a MAC address.

Further, since the PHY header including an SIG includes information necessary for data demodulation, it is desirable to have resistance to radio error. Furthermore, it is desirable that the PHY header be correctly received by a wireless LAN device other than a wireless LAN device serving as the destination. Based on the fact that there is a wireless LAN device with a poor communication environment, it is desirable to configure a modulation scheme and coding rate with high redundancy for a PHY header, particularly, an SIG. For example, a communication apparatus can configure a modulation scheme with a low modulation order such as BPSK modulation or a low coding rate in the PHY header.

An MPDU includes a MAC layer header (MAC header) including header information and the like for performing signal processing in the MAC layer, a MAC service data unit (MSDU) or a frame body that is a data unit processed in the MAC layer, and a frame check sequence (FCS) for checking whether there is an error in a frame. In addition, multiple MSDUs can be aggregated as an Aggregated MSDU (A-MSDU).

Frame types of a transmission frame of the MAC layer are generally classified into three frame types, namely a management frame for managing a connection state and the like between apparatuses, a control frame for managing a communication state between apparatuses, and a data frame including actual transmission data, and each frame type is further classified into multiple types of subframes. The control frame includes a reception completion notification (Acknowledge or Ack) frame, a transmission request (Request to send or RTS) frame, a reception preparation completion (Clear to send or CTS) frame, and the like. The management frame includes a beacon frame, a probe request frame, a probe response frame, an authentication frame, a connection request (Association request) frame, a connection response (Association response) frame, and the like. The data frame includes a data frame, a polling (CF-poll) frame, and the like. Each apparatus can recognize the frame type and the subframe type of a received frame by interpreting contents of the frame control field included in the MAC header.

Further, an Ack may include a Block Ack. A Block Ack can give a reception completion notification with respect to multiple MPDUs.

The beacon frame includes a field in which an interval at which a beacon is transmitted (beacon interval) and an SSID are described. The base station apparatus can periodically broadcast a beacon frame within a BSS, and each terminal apparatus can recognize the base station apparatus in the surroundings of the terminal apparatus by receiving the beacon frame. The action of the terminal apparatus recognizing the base station apparatus based on the beacon frame broadcast from the base station apparatus will be referred to as passive scanning. On the other hand, the action of the terminal apparatus searching for the base station apparatus by broadcasting a probe request frame in the BSS will be referred to as active scanning. The base station apparatus can transmit a probe response frame in response to the probe request frame, and details described in the probe response frame are equivalent to those in the beacon frame.

The terminal apparatus recognizes the base station apparatus and performs a connection process with respect to the base station apparatus. The connection process is classified into an authentication procedure and a connection (association) procedure. The terminal apparatus transmits an authentication frame (authentication request) to the base station apparatus desiring a connection. Once the base station apparatus receives the authentication frame, then the base station apparatus transmits, to the terminal apparatus, an authentication frame (authentication response) including a status code indicating whether authentication can be made for the terminal apparatus. The terminal apparatus can determine whether the terminal apparatus has been authenticated by the base station apparatus by interpreting the status code described in the authentication frame. Further, the base station apparatus and the terminal apparatus can exchange the authentication frame multiple times.

After the authentication procedure, the terminal apparatus transmits a connection request frame to the base station apparatus in order to perform the connection procedure. Once the base station apparatus receives the connection request frame, the base station apparatus determines whether to allow the connection to the terminal apparatus and transmits a connection response frame to notify the terminal apparatus of the intent. In the connection response frame, an association identifier (AID) for identifying the terminal apparatus is described in addition to the status code indicating whether to perform the connection process. The base station apparatus can manage multiple terminal apparatuses by configuring different AIDs for the terminal apparatuses for which the base station apparatus has allowed connection.

After the connection process is performed, the base station apparatus and the terminal apparatus perform actual data transmission. In the IEEE 802.11 system, a distributed coordination function (DCF), a point coordination function (PCF), and mechanisms in which the aforementioned mechanisms are enhanced (an enhanced distributed channel access (EDCA) or a hybrid control mechanism (hybrid coordination function (HCF)), and the like) are defined. A case that the base station apparatus transmits signals to the terminal apparatus using the DCF will be described below as an example.

In the DCF, the base station apparatus and the terminal apparatus perform carrier sensing (CS) for checking usage of a radio channel in the surroundings of the apparatuses prior to communication. In a case that the base station apparatus serving as a transmitting station receives a signal of a higher level than a predefined clear channel assessment level (CCA level) on a radio channel, transmission of transmission frames on the radio channel is postponed. Hereinafter, a state in which a signal of a level that is equal to or higher than the CCA level is detected on the radio channel will be referred to as a busy (Busy) state, and a state in which a signal of a level that is equal to or higher than the CCA level is not detected will be referred to as an idle (Idle) state. In this manner, CS performed based on power of a signal actually received by each apparatus (reception power level) is called physical carrier sense (physical CS). Further, the CCA level is also called a carrier sense level (CS level) or a CCA threshold (CCAT). Further, in a case that a signal of a level that is equal to or higher than the CCA level has been detected, the base station apparatus and the terminal apparatus start to perform an operation of demodulating at least a signal of the PHY layer.

Further, a simple description of carrier sense below includes a case that virtual carrier sense to be described below is performed. In addition, a simple description of carrier sense level below includes a case that it indicates a minimum reception sensitivity indicating a received signal power at which a communication apparatus demodulates at least a signal of the PHY layer. That is, in a case that a received signal power of a frame as a received signal power equal to or greater than the minimum reception sensitivity is observed in receiving the frame, the communication apparatus needs to demodulate at least a signal of the PHY layer for the frame. In the case that the communication apparatus observes a received signal power lower than or equal to the minimum reception sensitivity, the communication apparatus is able to plan to perform frame transmission, without having to demodulate the frame. Thus, it can be said that a carrier sense level and the minimum reception sensitivity have the same meaning.

The base station apparatus performs carrier sensing by an inter-frame space (IFS) in accordance with the type of transmission frame to be transmitted and determines whether the radio channel is in a busy state or idle state. A period in which the base station apparatus performs carrier sensing varies depending on the frame type and the subframe type of a transmission frame to be transmitted by the base station apparatus. In the IEEE 802.11 system, multiple IFSs with different periods are defined, and there are a short frame interval (Short IFS or SIFS) used for a transmission frame with the highest priority given, a polling frame interval (PCF IFS or PIFS) used for a transmission frame with a relatively high priority, a distribution control frame interval (DCF IFS or DIFS) used for a transmission frame with the lowest priority, and the like. In a case that the base station apparatus transmits a data frame with the DCF, the base station apparatus uses the DIFS.

The base station apparatus waits by DIFS and then further waits for a random backoff time to prevent frame collision. In the IEEE 802.11 system, a random backoff time called a contention window (CW) is used. CSMA/CA works with the assumption that a transmission frame transmitted by a certain transmitting station is received by a receiving station in a state in which there is no interference from other transmitting stations. Therefore, in a case that transmitting stations transmit transmission frames at the same timing, the frames collide against each other, and the receiving station cannot receive them properly. Thus, each transmitting station waits for a randomly configured time before starting transmission, and thus collision of frames can be avoided. In a case that the base station apparatus determines, through carrier sensing, that a radio channel is in an idle state, the base station apparatus starts to count down CW, acquires a transmission right for the first time after CW becomes zero, and can transmit the transmission frame to the terminal apparatus. Further, in a case that the base station apparatus determines through the carrier sensing that the radio channel is in a busy state during the count-down of CW, the base station apparatus stops the count-down of CW. In addition, in a case that the radio channel is in an idle state, then the base station apparatus restarts the count-down of the remaining CW after the previous IFS.

A terminal apparatus that is a receiving station receives a transmission frame, interprets the PHY header of the transmission frame, and demodulates the received transmission frame. Then, the terminal apparatus interprets the MAC header of the demodulated signal and thus can recognize whether the transmission frame is addressed to the terminal apparatus itself. Further, the terminal apparatus can also determine the destination of the transmission frame based on information described in the PHY header (for example, a group identifier (Group ID or GID) listed in VHT-SIG-A).

In a case that the terminal apparatus determines that the received transmission frame is addressed to the terminal apparatus and has been able to demodulate the transmission frame without any error, the terminal apparatus has to transmit an ACK frame indicating that the frame has been properly received to the base station apparatus that is the transmitting station. The ACK frame is one of transmission frames with the highest priority transmitted only after a wait for the SIFS period (with no random backoff time). The base station apparatus ends the series of communication with the reception of the ACK frame transmitted from the terminal apparatus. Further, in a case that the terminal apparatus is not able to receive the frame properly, the terminal apparatus does not transmit ACK. Thus, in a case that the ACK frame has not been received from the receiving station for a certain period (a length of SIFS+ACK frame) after the transmission of the frame, the base station apparatus assumes that the communication has failed and ends the communication. In this manner, an end of a single communication operation (also called a burst) in the IEEE 802.11 system must be determined based on whether an ACK frame has been received except for special cases such as a case of transmission of a broadcast signal such as a beacon frame, a case that fragmentation for splitting transmission data is used, or the like.

In a case that the terminal apparatus determines that the received transmission frame is not addressed to the terminal apparatus itself, the terminal apparatus configures a network allocation vector (NAV) based on the length of the transmission frame described in the PHY header or the like. The terminal apparatus does not attempt communication during the period configured in the NAV. In other words, because the terminal apparatus performs the same operation as in the case that the terminal apparatus determines the radio channel is in a busy state through physical CS for the period configured in the NAV, the communication control based on the NAV is also called virtual carrier sensing (virtual CS). The NAV is also configured by a request to send (RTS) frame or a clear to send (CTS) frame, which are introduced to solve a hidden terminal problem in addition to the case that the NAV is configured based on the information described in the PHY header.

Unlike the DCF in which each apparatus performs carrier sensing and autonomously acquires the transmission right, with respect to the PCF, a control station called a point coordinator (PC) controls the transmission right of each apparatus within a BSS. In general, the base station apparatus serves as a PC and acquires the transmission right of the terminal apparatus within a BSS.

A communication period using the PCF includes a contention-free period (CFP) and a contention period (CP). Communication is performed based on the aforementioned DCF during a CP, and a PC controls the transmission right during a CFP. The base station apparatus serving as a PC broadcasts a beacon frame with description of a CFP period (CFP max duration) and the like in a BSS prior to communication with a PCF. Further, the PIFS is used for transmission of the beacon frame broadcast at the time of a start of transmission by the PCF, and the beacon frame is transmitted without waiting for CW. Further, the terminal apparatus that has received the beacon frame configures the CFP period described in the beacon frame in an NAV. Hereinafter, the terminal apparatus can acquire the transmission right only in a case that a signal (e.g., a data frame including CF-poll) for broadcasting the acquisition of the transmission right transmitted by the PC is received until the NAV elapses or a signal (e.g., a data frame including CF-end) broadcasting the end of the CFP in the BSS is received. Further, because no packet collision occurs in the same BSS during the CFP period, each terminal apparatus does not take a random backoff time used for the DCF.

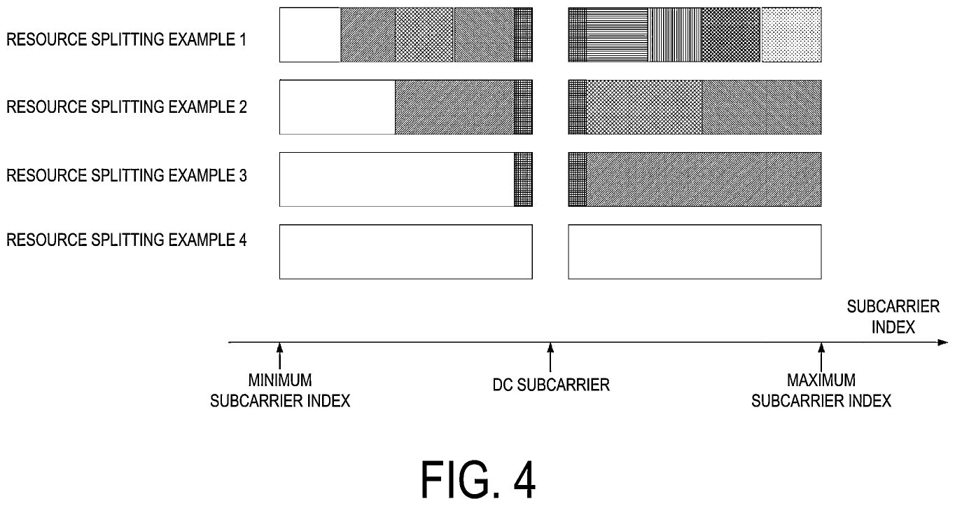

A radio medium can be split into multiple resource units (RUs). FIG. 4 is a schematic diagram illustrating an example of a split state of a radio medium. In a resource splitting example 1, for example, a wireless communication apparatus can a split frequency resources (subcarrier, frequency tone, and tone) that is a radio medium into nine RUs. Similarly, in a resource splitting example 2, the wireless communication apparatus can split a subcarrier that is a radio medium into five RUs. It is a matter of course that the resource splitting examples illustrated in FIG. 4 are merely examples, and for example, each of multiple RUs can include a different number of subcarriers. Moreover, the radio medium that is split into RUs can include not only a frequency resource but also a spatial resource. The wireless communication apparatus (e.g., an AP) can transmit frames to multiple terminal apparatuses (e.g., multiple STAs) at the same time by allocating frames addressed to different terminal apparatuses in each RU. An AP can describe information indicating a split state of the radio medium (resource allocation information) as common control information in the PHY header of the frame transmitted by the AP itself. Moreover, the AP can describe information indicating an RU in which a frame addressed to each STA is allocated (resource unit assignment information) as unique control information in the PHY header of the frame transmitted by the AP itself.

In addition, multiple terminal apparatuses (e.g., multiple STAs) can transmit frames at the same time by allocating and transmitting the frames in the RUs allocated to themselves, respectively. The multiple STAs can perform frame transmission after waiting for a predetermined period after receiving the frame including trigger information transmitted from the AP (trigger frame or TF). Each STA can recognize the RU allocated to the STA itself based on the information described in the TF. In addition, each STA can acquire the RU through random access with reference to the TF.

The AP can allocate multiple RUs to one STA at the same time. The multiple RUs can include continuous subcarriers or can include discontinuous subcarriers. The AP can transmit one frame using multiple RUs allocated to one STA or can transmit multiple frames after allocating them to different RUs. At least one of the multiple frames can be a frame including common control information for multiple terminal apparatuses that transmit resource allocation information.

One STA can be allocated multiple RUs by the AP. The STA can transmit one frame using the multiple allocated RUs. Also, the STA can use the multiple allocated RUs to transmit multiple frames allocated to different RUs. The multiple frames can be frames of different types.

The AP can allocate multiple association Ids (AIDs) to one STA. The AP can allocate an RU to each of the multiple AIDs allocated to the one STA. The AP can transmit different frames using the RUs allocated to the multiple AIDs allocated to the one STA. The different frames can be frames of different types.

One STA can be allocated multiple associate Ids (AIDs) by the AP. The one STA can be allocated an RU with respect to the multiple allocated AIDs. The one STA recognizes all of the RUs allocated to each of the multiple AIDs allocated to the STA itself as RUs allocated to the STA itself and can transmit one frame using the multiple allocated RUs. In addition, the one STA can transmit multiple frames using the multiple allocated RUs. At this time, the multiple frames can be transmitted with information indicating the AIDs associated with each of the allocated RUs described therein. The AP can transmit different frames using the RUs allocated to the multiple AIDs allocated to the one STA. The different frames can be frames of different types.

Hereinafter, the base station apparatus and the terminal apparatuses will be collectively referred to as wireless communication apparatuses or communication apparatuses. In addition, information exchanged in a case that a certain wireless communication apparatus performs communication with another wireless communication apparatus will also be referred to as data. In other words, wireless communication apparatuses include a base station apparatus and a terminal apparatus.

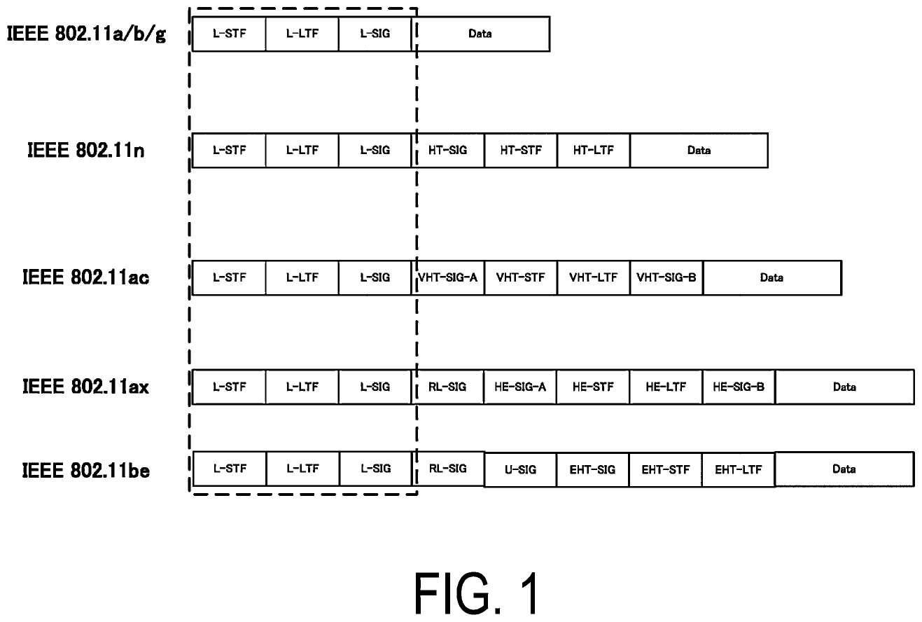

A wireless communication apparatus includes any one of or both the function of transmitting a PPDU and a function of receiving a PPDU. FIG. 1 is a diagram illustrating examples of configurations of a PPDU transmitted by a wireless communication apparatus. A PPDU that is compliant with the IEEE 802.11a/b/g standard includes L-STF, L-LTF, L-SIG, and a data frame (a MAC frame, a MAC frame, a payload, a data part, data, information bits, and the like). A PPDU that is compliant with the IEEE 802.11n standard includes L-STF, L-LTF, L-SIG, HT-SIG, HT-STF, HT-LTF, and a data frame. A PPDU that is compliant with the IEEE 802.11ac standard includes some or all of L-STF, L-LTF, L-SIG, VHT-SIG-A, VHT-STF, VHT-LTF, VHT-SIG-B, and a MAC frame. A PPDU studied in the IEEE 802.11ax standard includes some or all of L-STF, L-LTF, L-SIG, RL-SIG in which L-SIG is temporally repeated, HE-SIG-A, HE-STF, HE-LTF, HE-SIG-B, and a data frame. A PPDU studied in the IEEE 802.11be standard includes some or all of L-STF, L-LTF, L-SIG, RL-SIG, U-SIG, EHT-SIG, EHT-STF, HET-LTF, and a data frame.

L-STF, L-LTF, and L-SIG surrounded by the dotted line in FIG. 1 are configurations commonly used in the IEEE 802.11 standard (hereinafter, L-STF, L-LTF, and L-SIG will also be collectively referred to as an L-header). For example, a wireless communication apparatus that is compliant with the IEEE 802.11a/b/g standard can appropriately receive an L-header inside a PPDU that is compliant with the IEEE 802.11n/ac standard. A wireless communication apparatus that is compliant with the IEEE 802.11a/b/g standard can receive the PPDU that is compliant with the IEEE 802.11n/ac standard while considering it to be a PPDU that is compliant with the IEEE 802.11a/b/g standard.

However, because the wireless communication apparatus that is compliant with the IEEE 802.11a/b/g standard cannot demodulate the PPDU that is compliant with the IEEE 802.11n/ac standard following the L-header, it is not possible to demodulate information about a transmitter address (TA), a receiver address (RA), and a duration/ID field used for configuring an NAV.

As a method for the wireless communication apparatus that is compliant with the IEEE 802.11a/b/g standard to appropriately configure an NAV (or to perform a receiving operation for a predetermined period), IEEE 802.11 defines a method of inserting duration information to the L-SIG. Information about a transmission speed in the L-SIG (a RATE field, an L-RATE field, an L-RATE, an L_DATARATE, and an L_DATARATE field) and information about a transmission period (a LENGTH field, an L-LENGTH field, and an L-LENGTH) are used by the wireless communication apparatus that is compliant with the IEEE 802.11a/b/g standard to appropriately configure an NAV.

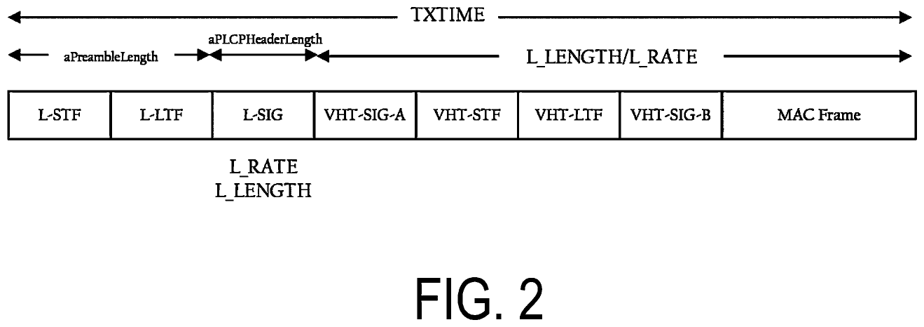

FIG. 2 is a diagram illustrating an example of a method for duration information inserted into an L-SIG. Although a PPDU configuration that is compliant with the IEEE 802.11ac standard is illustrated as an example in FIG. 2, a PPDU configuration is not limited thereto. A PPDU configuration that is compliant with the IEEE 802.11n standard and a PPDU configuration that is compliant with the IEEE 802.11ax standard may be employed. TXTIME includes information about a length of a PPDU, aPreambleLength includes information about a length of a preamble (L-STF+L-LTF), and aPLCPHeaderLength includes information about a length of a PLCP header (L-SIG). L_LENGTH is calculated based on Signal Extension that is a virtual period configured for compatibility with the IEEE 802.11 standard, Nₒₚₛ related to L-RATE, aSymbolLength that is information about one symbol (a symbol, an OFDM symbol, or the like), aPLCPServiceLength indicating the number of bits included in PLCP Service field, and aPLCPConvolutionalTailLength indicating the number of tail bits of a convolution code. The wireless communication apparatus can calculate L_LENGTH and insert L_LENGTH into L-SIG. In addition, the wireless communication apparatus can calculate L-SIG Duration. L-SIG Duration indicates information about a PPDU including L_LENGTH and information about a period that is the sum of periods of Ack and SIFS expected to be transmitted by the destination wireless communication apparatus in response to the PPDU.

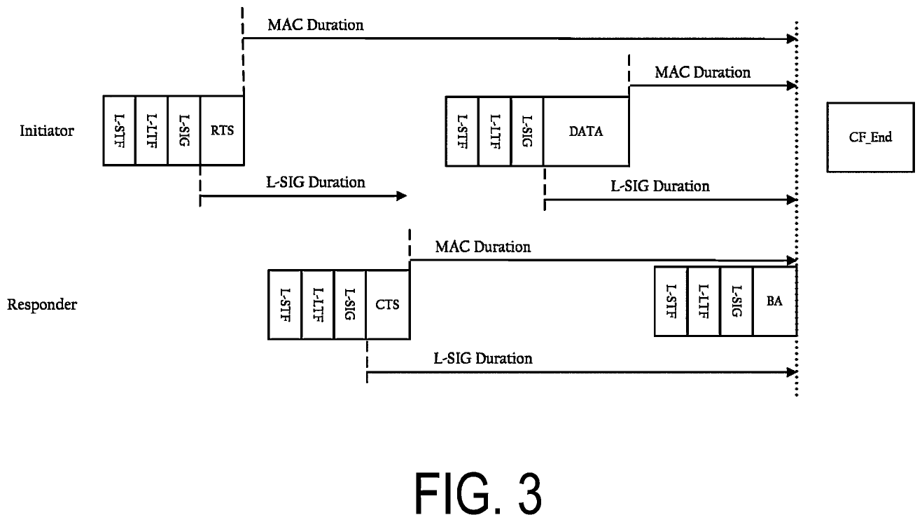

FIG. 3 is a diagram illustrating an example of L-SIG Duration in L-SIG TXOP Protection. DATA (a frame, a payload, data, and the like) include some of or both the MAC frame and the PLCP header. In addition, BA includes Block Ack or Ack. A PPDU includes L-STF, L-LTF, and L-SIG and can further include any one or more of DATA, BA, RTS, or CTS. Although L-SIG TXOP Protection using RTS/CTS is illustrated in the example illustrated in FIG. 3, CTS-to-Self may be used. Here, MAC Duration is a period indicated by a value of Duration/ID field. Furthermore, Initiator can transmit a CF_End frame for providing a notification regarding an end of the L-SIG TXOP Protection period.

Next, a method of identifying a BSS from a frame received by a wireless communication apparatus will be described. In order for a wireless communication apparatus to identify a BSS from a received frame, the wireless communication apparatus that transmits a PPDU preferably inserts information for identifying the BSS (BSS color, BSS identification information, or a value unique to the BSS) into the PPDU. The information indicating the BSS color can be described in HE-SIG-A.

The wireless communication apparatus can transmit L-SIG multiple times (L-SIG Repetition). For example, demodulation accuracy of L-SIG is improved by the wireless communication apparatus on the reception side receiving L-SIG transmitted multiple times by using Maximum Ratio Combining (MRC). Moreover, in a case that reception of L-SIG has been properly completed using MRC, the wireless communication apparatus can interpret the PPDU including the L-SIG as a PPDU that is compliant with the IEEE 802.11ax standard.

Even during the operation of receiving the PPDU, the wireless communication apparatus can perform an operation of receiving part of a PPDU other than the corresponding PPDU (e.g., the preamble, L-STF, L-LTF, and the PLCP header prescribed by IEEE 802.11) (also referred to as a dual-reception operation). In a case that a part of a PPDU other than the PPDU is detected during the operation of receiving the PPDU, the wireless communication apparatus can update a part or an entirety of information about a destination address, a transmission source address, a PPDU, or a DATA period.

An Ack and a BA can also be referred to as a response (response frame). In addition, a probe response, an authentication response, and a connection response can also be referred to as a response.

### 1. First Embodiment

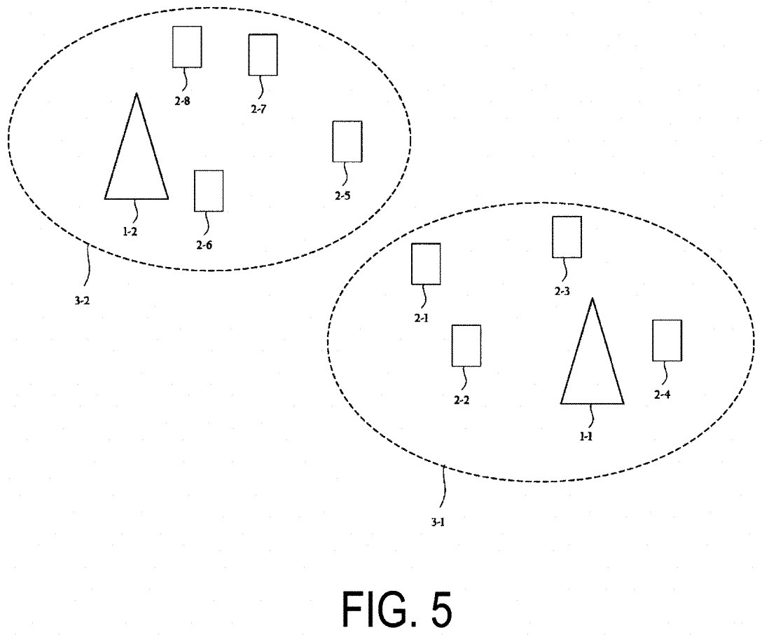

FIG. 5 is a diagram illustrating an example of a wireless communication system according to the present embodiment. A wireless communication system 3-1 includes a wireless communication apparatus 1-1 and wireless communication apparatuses 2-1 to 2-4. Further, the wireless communication apparatus 1-1 will also be referred to as a base station apparatus 1-1, and the wireless communication apparatuses 2-1 to 2-4 will also be referred to as terminal apparatuses 2-1 to 2-4. In addition, the wireless communication apparatuses 2-1 to 2-4 and the terminal apparatuses 2-1 to 2-4 will also be referred to as a wireless communication apparatus 2A and a terminal apparatus 2A, respectively, as apparatuses connected to the wireless communication apparatus 1-1. The wireless communication apparatus 1-1 and the wireless communication apparatus 2A are wirelessly connected and are in a state in which they can transmit and/or receive PPDUs to and from each other. In addition, the wireless communication system according to the present embodiment includes a wireless communication system 3-2 in addition to the wireless communication system 3-1. The wireless communication system 3-2 includes a wireless communication apparatus 1-2 and wireless communication apparatuses 2-5 to 2-8. Further, the wireless communication apparatus 1-2 will also be referred to as a base station apparatus 1-2 and the wireless communication apparatuses 2-5 to 2-8 will also be referred to as terminal apparatuses 2-5 to 2-8. Further, in addition, the wireless communication apparatuses 2-5 to 2-8 and terminal apparatuses 2-5 to 2-8 will also be referred to as a wireless communication apparatus 2B and a terminal apparatus 2B, respectively, as apparatuses connected to the wireless communication apparatus 1-2. Although the wireless communication system 3-1 and the wireless communication system 3-2 form different BSSs, this does not necessarily mean that extended service sets (ESSs) are different. An ESS indicates a service set forming a local area network (LAN). In other words, wireless communication apparatuses belonging to the same ESS can be regarded as belonging to the same network from an upper layer. Further, the wireless communication systems 3-1 and 3-2 can further include multiple wireless communication apparatuses.

In FIG. 5, it is assumed that signals transmitted by the wireless communication apparatus 2A arrive at the wireless transmission apparatus 1-1 and the wireless communication apparatus 2B, but do not arrive at the wireless communication apparatus 1-2 in the following description. In other words, in a case that the wireless communication apparatus 2A transmits a signal using a certain channel, whereas the wireless communication apparatus 1-1 and the wireless communication apparatus 2B determine that the channel is in a busy state, the wireless communication apparatus 1-2 determines that the channel is in an idle state. In addition, it is assumed that signals transmitted by the wireless communication apparatus 2B arrive at the wireless transmission apparatus 1-2 and the wireless communication apparatus 2A, but do not arrive at the wireless communication apparatus 1-1. In other words, in a case that the wireless communication apparatus 2B transmits a signal using a certain channel, whereas the wireless communication apparatus 1-2 and the wireless communication apparatus 2A determine that the channel is in a busy state, the wireless communication apparatus 1-1 determines that the channel is in an idle state.

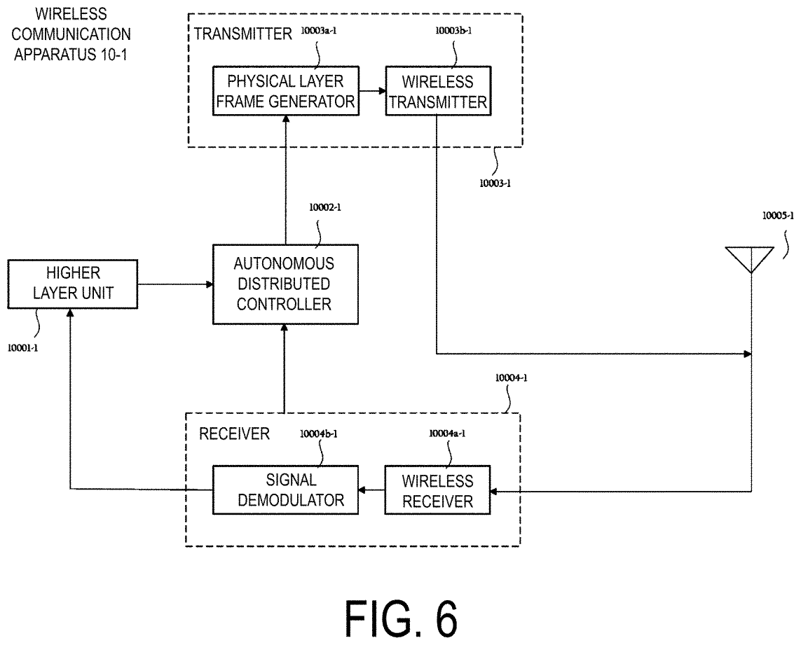

FIG. 6 is a diagram illustrating an example of an apparatus configuration of the wireless communication apparatuses 1-1, 1-2, 2A, and 2B (hereinafter, collectively referred to as a wireless communication apparatus 10-1 or a station apparatus 10-1 or also simply referred to as a station apparatus). The wireless communication apparatus 10-1 includes an higher layer unit (upper layer processing step) 10001-1, an autonomous distributed controller (autonomous distributed control step) 10002-1, a transmitter (transmission step) 10003-1, a receiver (reception step) 10004-1, and an antenna 10005-1.

The higher layer unit 10001-1 is connected to another network and can notify the autonomous distributed controller 10002-1 of information about traffic. The information about traffic may be, for example, information addressed to other wireless communication apparatuses, or may be control information included in a management frame or a control frame.

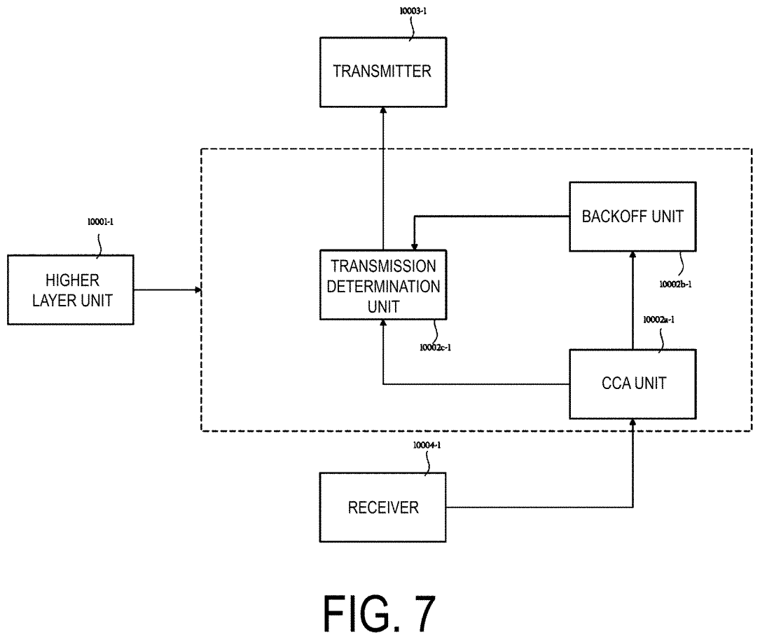

FIG. 7 is a diagram illustrating an example of an apparatus configuration of the autonomous distributed controller 10002-1. The autonomous distributed controller 10002-1 includes a CCA unit (CCA step) 10002a-1, a backoff unit (backoff step) 10002b-1, and a transmission determination unit (transmission determination step) 10002c-1.

The CCA unit 10002a-1 uses any one of or both information about received signal power received via radio resources and information about the reception signal (including information after decoding), which are notified of from the receiver, to determine a state of the radio resources (including determining whether the state is busy or idle). The CCA unit 10002a-1 can notify the backoff unit 10002b-1 and the transmission determination unit 10002c-1 of the state determination information of the radio resources.

The backoff unit 10002b-1 can perform backoff using the state determination information of the radio resources. The backoff unit 10002b-1 has a function of generating a CW and counting down it. For example, countdown of CW is performed in a case that the state determination information of the radio resources indicates idle, and the countdown of the CW can be stopped in a case that the state determination information of the radio resources indicates busy. The backoff unit 10002b-1 can notify the transmission determination unit 10002c-1 of the value of the CW.

The transmission determination unit 10002c-1 performs transmission determination using any one of or both the state determination information of the radio resources and the value of the CW. For example, the transmitter 10003-1 can be notified of transmission determination information in a case that the state determination information of the radio resources indicates idle and the value of the CW is zero. In addition, the transmitter 10003-1 can be notified of the transmission determination information in a case that the state determination information of the radio resources indicates idle.

The transmitter 10003-1 includes a physical layer frame generator (physical layer frame generation step) 10003a-1 and a wireless transmitter (wireless transmission step) 10003b-1. The physical layer frame generator 10003a-1 has a function of generating a physical layer frame (PPDU) based on the transmission determination information notified of from the transmission determination unit 10002c-1. The physical layer frame generator 10003a-1 performs error correction coding, modulation, precoding filter multiplication, and the like on transmission frames sent from the upper layer. The physical layer frame generator 10003a-1 notifies the wireless transmitter 10003b-1 of the generated physical layer frame.

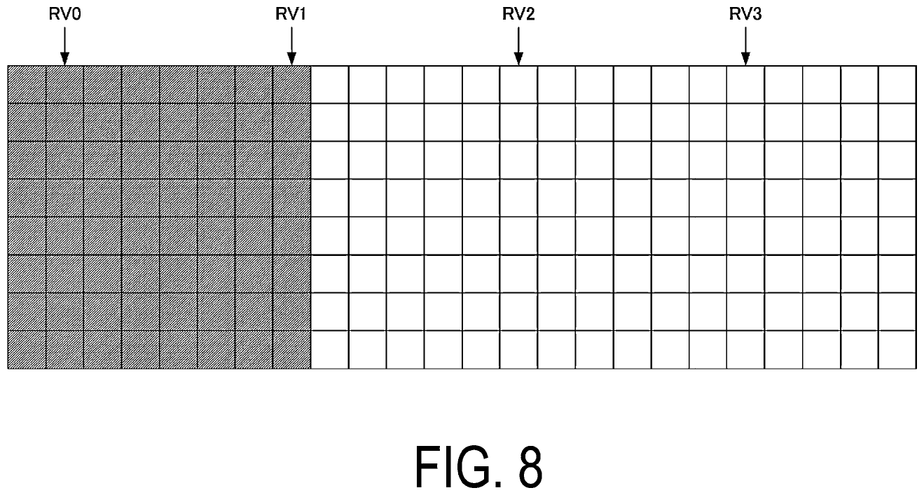

FIG. 8 is a diagram illustrating an example of error correction coding of the physical frame generator according to the present embodiment. An information bit (systematic bit) sequence is allocated in the hatching region and a redundancy (parity) bit sequence is arranged in the white region as illustrated in FIG. 8. Bit interleaving is appropriately applied to each of the information bits and the redundancy bits. The physical frame generator can read a necessary number of bits as a starting position determined for the allocated bit sequence in accordance with a value of redundancy version (RV). Flexible change in coding rate, that is puncturing, is possible by adjusting the number of bits. Further, although a total of four RVs are illustrated in FIG. 8, the number of options for RV is not limited to a specific value in the error correction coding according to the present embodiment. Station apparatuses need to share positions of RVs.

Although the physical layer frame generator performs error correction coding on the information bits transferred from the MAC layer, a unit in which error correction coding (coding block length) is performed is not limited. For example, the physical layer frame generator can divide the information bit sequence transferred from the MAC layer into information bit sequences having a predetermined length to perform error correction coding on each of the sequences, and thus can make the sequences into multiple coding blocks. Further, dummy bits can be inserted into the information bit sequence transferred from the MAC layer in a case that coding blocks are configured.

The frame generated by the physical layer frame generator 10003a-1 includes control information. The control information includes information indicating in which RU the data addressed to each wireless communication apparatus is allocated (here, the RU including both frequency resources and spatial resources). In addition, the frame generated by the physical layer frame generator 10003a-1 includes a trigger frame for indicating frame transmission to the wireless communication apparatus that is a destination terminal. The trigger frame includes information indicating the RU to be used by the wireless communication apparatus that has received the indication for the frame transmission to transmit the frame.

The wireless transmitter 10003b-1 converts the physical layer frame generated by the physical layer frame generator 10003a-1 into a signal in a radio frequency (RF) band to generate a radio frequency signal. Processing performed by the wireless transmitter 10003b-1 includes digital-to-analog conversion, filtering, frequency conversion from a baseband to an RF band, and the like.

The receiver 10004-1 includes a wireless receiver (wireless reception step) 10004a-1 and a signal demodulator (signal demodulation step) 10004b-1. The receiver 10004-1 generates information about received signal power from a signal in the RF band received by the antenna 10005-1. The receiver 10004-1 can notify the CCA unit 10002a-1 of the information about the received signal power and the information about the reception signal.

The wireless receiver 10004a-1 has a function of converting a signal in the RF band received by the antenna 10005-1 into a baseband signal and generating a physical layer signal (e.g., a physical layer frame). Processing performed by the wireless receiver 10004a-1 includes frequency conversion processing from the RF band to the baseband, filtering, and analog-to-digital conversion.

The signal demodulator 10004b-1 has a function of demodulating a physical layer signal generated by the wireless receiver 10004a-1. Processing performed by the signal demodulator 10004b-1 includes channel equalization, demapping, error correction decoding, and the like. The signal demodulator 10004b-1 can extract, from the physical layer signal, information included in the PHY header, information included in the MAC header, and information included in the transmission frame, for example. The signal demodulator 10004b-1 can notify the higher layer unit 10001-1 of the extracted information. Further, the signal demodulator 10004b-1 can extract any one or all of the information included in the PHY header, the information included in the MAC header, and the information included in the transmission frame.

The antenna 10005-1 has a function of transmitting a radio frequency signal generated by the wireless transmitter 10003b-1 into the wireless space toward a wireless apparatus 0-1. In addition, the antenna 10005-1 has a function of receiving a radio frequency signal transmitted by the wireless apparatus 0-1.

The wireless communication apparatus 10-1 can describe, in the PHY header or the MAC header of the frame to be transmitted, information indicating the period in which the apparatus itself uses the radio medium to configure an NAV for the period for a wireless communication apparatus around the aforementioned apparatus. For example, the wireless communication apparatus 10-1 can describe the information indicating the period in a Duration/ID field or a Length field of the frame to be transmitted. The NAV period configured for the wireless communication apparatuses around the wireless communication apparatus itself will be referred to as a TXOP period (or simply TXOP) acquired by the wireless communication apparatus 10-1. In addition, the wireless communication apparatus 10-1 that has acquired the TXOP will be referred to as a TXOP acquirer (TXOP holder). The type of frame to be transmitted by the wireless communication apparatus 10-1 to acquire TXOP is not limited to any frame type, and the frame may be a control frame (e.g., an RTS frame or a CTS-to-self frame) or may be a data frame.

The wireless communication apparatus 10-1 that is a TXOP holder can transmit the frame to a wireless communication apparatus other than the wireless communication apparatus itself during the TXOP. In a case that the wireless communication apparatus 1-1 is a TXOP holder, the wireless communication apparatus 1-1 can transmit a frame to the wireless communication apparatus 2A during the TXOP period. In addition, the wireless communication apparatus 1-1 can indicate to the wireless communication apparatus 2A to transmit a frame addressed to the wireless communication apparatus 1-1 during the TXOP period. The wireless communication apparatus 1-1 can transmit, to the wireless communication apparatus 2A, a trigger frame including information for indicating a frame transmission addressed to the wireless communication apparatus 1-1 during the TXOP period.

The wireless communication apparatus 1-1 may reserve a TXOP for the entire communication band (e.g., operation bandwidth) in which frame transmission is likely to be performed, or may reserve a TXOP for a specific communication band (Band) such as a communication band in which frames are actually transmitted (e.g., transmission bandwidth).

The wireless communication apparatus that indicates a frame transmission in the TXOP period acquired by the wireless communication apparatus 1-1 is not necessarily limited to a wireless communication apparatus connected to the wireless communication apparatus itself. For example, the wireless communication apparatus can indicate to wireless communication apparatuses that are not connected to the wireless communication apparatus itself to transmit a frame, in order to cause a wireless communication apparatus around the apparatus itself to transmit a management frame such as a reassociation frame or a control frame such as an RTS/CTS frame.

In the present embodiment, the signal demodulator of the station apparatus can perform a decoding process the received signal in the physical layer, and perform error detection. Here, the decoding process includes decoding of codes that have been error-corrected which is applied to the received signal. Here, the error detection includes error detection using an error detection code (e.g., a cyclic redundancy check (CRC) code) that has been given to the received signal in advance, and error detection using an error detection code (e.g., low-density parity-check code (LDPC)) having an error detection function from the first. The decoding processing in the physical layer can be applied for each coding block.

The higher layer unit transfers the result of decoding of the physical layer by the signal demodulator to the MAC layer. In the MAC layer, the signal of the MAC layer is restored from the transferred decoding result of the physical layer. Then, error detection is performed in the MAC layer, and it is determined that whether the signal of the MAC layer transmitted by the station apparatus as a transmission source of the reception frame has been correctly restored.

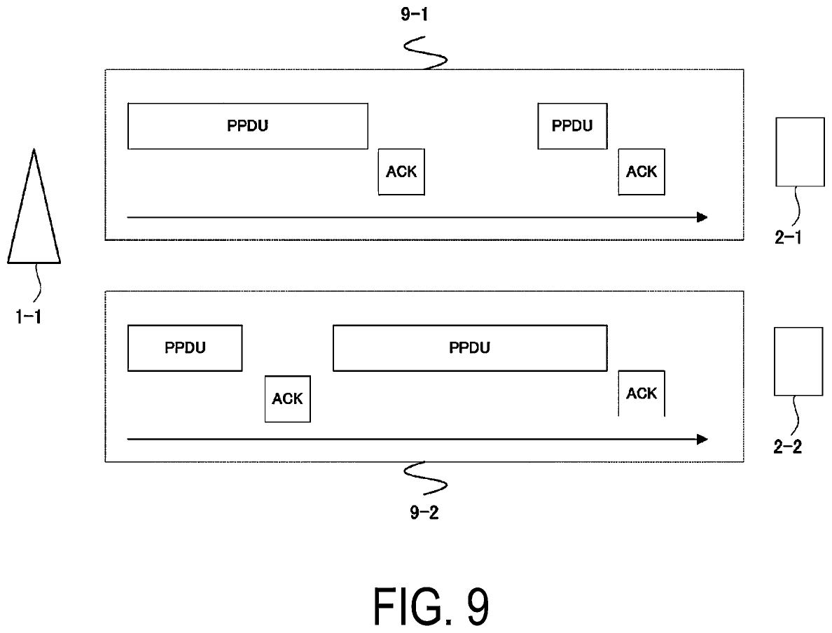

The communication apparatuses according to the present embodiment can maintain multiple connections (links). Here, “maintaining a connection” means that frames can be transmitted and/or received based on a predetermined configuration. FIG. 9 is a schematic diagram illustrating a state of communication according to the present embodiment. An access point apparatus 1-1 according to the present embodiment can maintain connections to a station apparatus 2-1 and a station apparatus 2-2 using respective different carrier frequencies as illustrated in FIG. 9. For example, the access point apparatus 1-1 according to the present embodiment can configure a 2.4 GHz band frequency for a connection 9-1 to the station apparatus 2-1 and configure a 5 GHz band frequency for a connection 9-2 to the station apparatus 2-2.

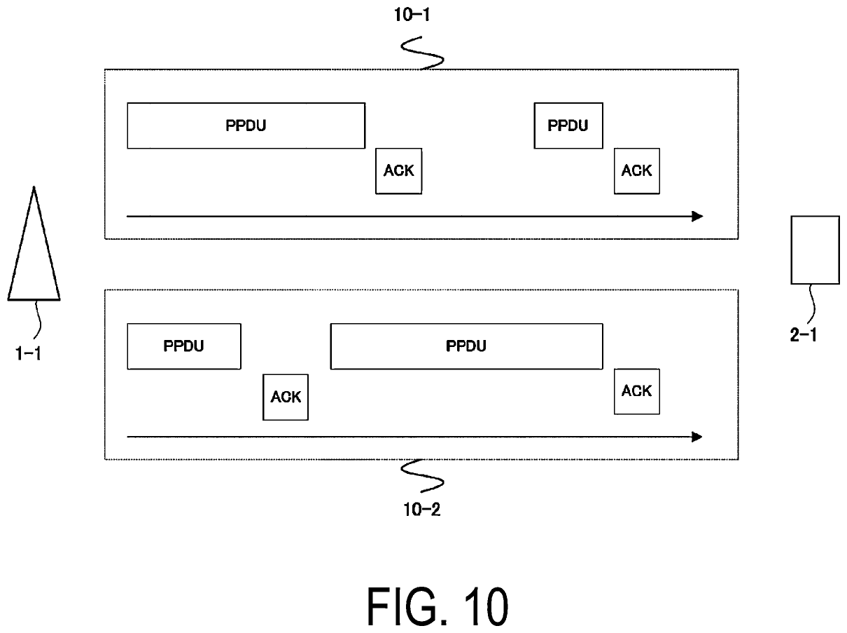

FIG. 10 is a schematic diagram illustrating another state of communication according to the present embodiment. Similarly, the access point apparatus 1-1 according to the present embodiment can maintain two connections to the station apparatus 2-1 as illustrated in FIG. 10. For example, a 2.4 GHz band frequency can be configured for a connection 10-1 and a 5 GHz band frequency can be configured for a connection 10-2. This configuration allows the access point apparatus 1-1 to perform the frame exchange with the station apparatus 2-1 using the two frequencies.

The communication apparatuses according to the present embodiment can determine whether frames are transmitted using multiple connections in accordance with a state of a radio medium. Frames can be transmitted with efficiency.

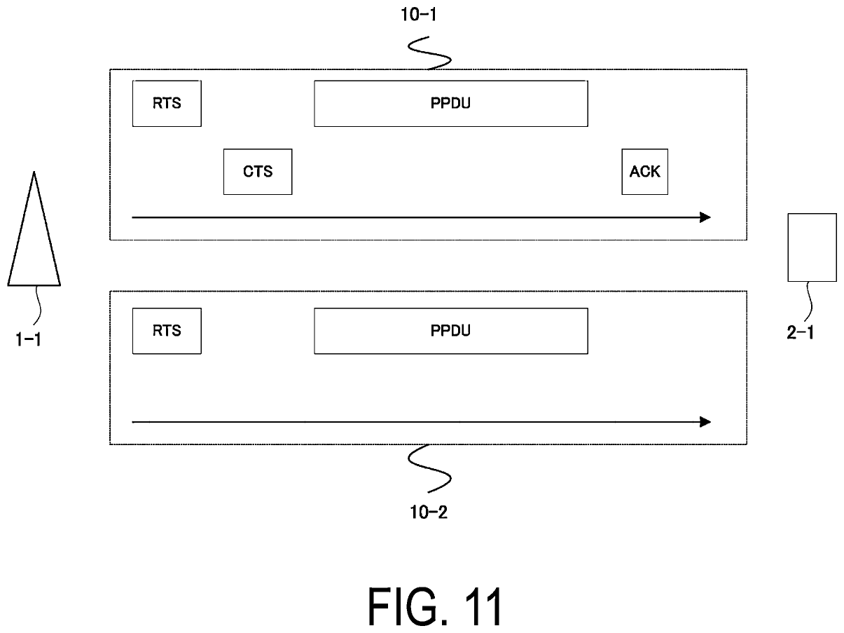

FIG. 11 is a schematic diagram illustrating another state of communication according to the present embodiment. According to the example of FIG. 11, the access point apparatus and the station apparatus can perform frame exchange using two connections of a connection 10-1 (first connection) and a connection 10-2 (second connection). Of course, the method according to the present embodiment also includes a case of three or more connections maintained by the access point apparatus. Here, the access point apparatus first transmits a medium reserving frame for reserving a radio medium for a certain period of time in each connection. The medium reserving frame includes information indicating a time interval in which the radio medium is reserved by the access point apparatus. Further, although the access point apparatus transmits a frame for reserving the radio medium at the same time for the connection 10-1 and the connection 10-2 according to the example of FIG. 11, the method of the present embodiment is not limited thereto. That is, the access point apparatus can transmit a frame for reserving a radio medium at different timings for multiple connections. However, even in this case, the end (end timing) of the period in which the radio medium reserving frame reserves the radio medium is desirably common for multiple connections. This indicates that time intervals (information associated with the NAV described in the frame) reserved by the medium reserving frame transmitted in each connection may match or differ.

The medium reserving frame is not limited to something. For example, the access point apparatus can transmit a request to end (RTS) frame in each connection as a frame for reserving the radio medium. In addition, the access point apparatus can transmit a multi-user RTS (MU-RTS) frame which is an RTS frame addressed to multiple users. Furthermore, the access point apparatus can transmit a trigger frame that solicits, as a frame for reserving the radio medium, a response frame (first response frame) radio medium from the station apparatus. In the following, a case that the access point apparatus transmits an RTS frame as a frame for reserving a radio medium will be described as an example.

The station apparatus that receives the RTS frame transmitted by the access point apparatus, in each connection, determines whether to transmit the first response frame (first frame) in a state of a radio medium of a connection that receives the RTS frame. For example, in a case that it is determined that the radio medium on which the RTS frame has been received is in an idle state, the station apparatus transmits, as a first response frame, a clear to send (CTS) frame in the connection in which the RTS frame has been received. On the other hand, in a case that it is determined that the radio medium of the connection in which the RTS frame has been received is in a busy state, the station apparatus does not transmit a CTS frame in the connection. Further, the first response frame transmitted by the station apparatus is not limited to a CTS frame. The station apparatus can transmit a control frame, a management frame and a data frame that are different from a CTS frame as a first response frame. However, it is desirable for the station apparatus to describe information indicating that the first response frame is a frame solicited by the access point apparatus in the first response frame. In addition, the access point apparatus can indicate the information described in the first response frame by the station apparatus.

In a connection in which the CTS frame has been received, the access point apparatus can determine that the radio medium of the connection can be reserved, and perform frame transmission. On the other hand, in a connection in which no CTS frame has been received, it is determined that a radio medium of the connection has not been reserved, and frame transmission is not performed. According to communication apparatuses of the related art, communication apparatuses can exchange an RTS frame and a CTS frame with each other and thus can reserve a radio medium with accuracy between the communication apparatuses. A case that the access point apparatus is not able to receive a CTS frame in the connection in which the access point apparatus can transmit an RTS frame means that the station apparatus that has received the RTS frame determines the radio medium to be in a busy state. At this time, the station apparatus is likely to determine the radio medium to be in a busy state due to a frame belonging to a BSS (OBSS frame) managed by an access point apparatus different from the access point apparatus. In a case that the station apparatus determines that the radio medium is in a busy state due to the OBSS frame, although the station apparatus is not able to plan frame transmission, there is a possibility that a frame reception operation is performed in the radio medium.

Thus, in a case that the station apparatus according to the present embodiment has received RTS frames in multiple connections, and a CTS frame can be transmitted as a response frame in at least one connection, the CTS frame can include information indicating a state of the radio medium in a connection other than the connection in which the CTS frame is transmitted. Further, although the case that the station apparatus transmits the CTS frame as a response frame is described in the following description as an example, the type of frame including the information indicating a state of the radio medium in a connection other than the connection in which the frame is transmitted is not limited to a CTS frame. Control frames, management frames, and data frames other than CTS frames are applicable. However, it is needless to say that, for the access point apparatus and the station apparatus that receives the response frame, the response frame needs to include information for recognizing that the information indicating a state of the radio medium in a connection other than the connection for transmitting the response frame is included. The information can be explicitly described in PHY header or MAC header. The access point apparatus and the station apparatus can be implicitly notified of the information by means of a modulation scheme or a signal point allocation applied to the response frame.

Here, the information indicating a state of the radio medium can be information indicating a state of the NAV configured in each connection by the station apparatus that transmits the CTS frame. For example, the station apparatus can describe information indicating whether the station apparatus has configured the NAV in the connection 10-2 for the CTS frame transmitted in the connection 10-1. In addition, the station apparatus can describe information indicating attributes included in the NAV, such as whether the NAV configured by the station apparatus in the connection 10-2 for the CTS frame transmitted in the connection 10-1 is an NAV configured by a frame associated with the BSS to which the station apparatus belongs (intra-NAV), an NAV configured by a frame associated with a BSS to which the station apparatus does not belong (inter-NAV, OBSS-NAV), an NAV configured in a case that the BSS to which the frame that caused to configure the NAV belongs is unclear (Basic-NAV), or the like.

The information indicating a state of the radio medium can be information indicating interference power in each connection. Here, the information indicating interference power includes a reception signal strength indicator (RSSI) or a reception channel power indicator (RCPI). Furthermore, the information indicating interference power includes information indicating reception power of the legacy header portion among the frames received by the station apparatus in the connection. The legacy header portion includes at least some of L-STF, L-LTF, and L-SIG. The station apparatus can notify the access point apparatus of the difference between the reception power desired in the second connection and the reception power of the header portion of the medium reserving frame received in the second connection.

Referring back to FIG. 11, while the access point apparatus that has received the CTS frame including the information indicating the radio medium of the connection 10-2 in the connection 10-1 is capable of transmitting a frame (second frame) to the station apparatus in the connection 10-1 after a predetermined period of time elapses, the access point apparatus can determine whether to transmit the frame to the station apparatus in the connection 10-2 using information indicating information of the radio medium of the connection 10-2.

For example, in a case that the information of the radio medium of the connection 10-2 indicates that the NAV configured by the station apparatus in the connection 10-2 is OBSS-NAV, the access point apparatus can transmit the frame in the connection 10-2. Although the reason has been described before, it is because, in a case that the frame that caused the station apparatus to determine that the radio medium of the connection 10-2 is in a busy state is an OBSS frame, the station apparatus is likely to be able to receive the frame even in a case of being unable to transmit the frame. Of course, the frame transmitted by the access point apparatus in the connection 10-2 is likely to have a decreasing reception signal to interference power ratio (SIR) due to the OBSS frame. The access point apparatus appropriately configures the modulation scheme and the coding rate to be applied to the frame, and thus the station apparatus can correctly receive the frame received in the connection 10-2.

For example, in a case that the information of the radio medium of the connection 10-2 is information indicating interference power measured by the station apparatus in the connection 10-2, the access point apparatus can transmit the frame in the connection 10-2 in a case that the station apparatus satisfies the desired reception quality in the connection 10-2.

In both the connection 10-1 and the connection 10-2, the station apparatus that has received the frame transmits a response frame (second response frame) solicited by the frame. For example, the station apparatus demodulates each frame in both the connection 10-1 and connection 10-2, and performs error determination. Then, an ACK frame including information indicating whether the frame has been successfully received is transmitted to the access point apparatus as a second response frame. At this moment, it is not preferable for the station apparatus to transmit a second response frame in the connection 10-2 in which the radio medium has been determined to be in a busy state due to the OBSS frame. Thus, the station apparatus can transmit, in the connection 10-1, the second response frame solicited by the frame received in the connection 10-2. Alternatively, the station apparatus can cause information including the second response frame solicited by the frame received in the connection 10-2 to be included in the second response frame solicited by the frame received in the connection 10-1 and transmit the information in the connection 10-1. In this way, it may also be described that, in the case that information including the second response frame solicited by the frame received in the connection 10-2 is included in the second response frame solicited by the frame received in the connection 10-1 and transmitted in the connection 10-1, the station apparatus transmits the second response frame in the connection 10-1.

In a case that the frame has been received in the connection 10-2, the station apparatus can determine whether to update the NAV. In the case that the frame has been received from the access point apparatus in the connection 10-2, the station apparatus may not update inter-NAV and Basic NAV. In addition, the station apparatus may not transmit the frame in the time interval in which the second response frame is transmitted in the connection 10-1. In other words, in a case that the station apparatus has received the frame from the access point apparatus in the connection 10-2, and in a case that the inter-NAV or Basic NAV expires during the reception of the frame while a demodulation process is performed on the frame, the station apparatus can update the NAV in the connection 10-1 in the time interval before the transmission of the second response frame is completed.

The access point apparatus can describe information indicating a connection in which the second response frame is transmitted in the PHY header or the MAC header of the frame to be transmitted for the station apparatus after the first response frame is received.

Although the connection in which the station apparatus transmits the second response frame can be configured by the access point apparatus as described above, the connection can be configured by the station apparatus. For example, the station apparatus may transmit the second response frame in the connection in which the first response frame has been transmitted. Further, in a case that there are multiple connections in which the first response frame is transmitted by the station apparatus, the station apparatus may randomly select a connection in which the second response frame is to be transmitted from among the multiple connections in which the first response frame has been transmitted, or may select a connection with the lowest frequency. In addition, priorities may be configured for the multiple connections in advance, and the station apparatus can transmit the second response frame in a connection with a higher priority.

The station apparatus can directly describe the information of the connection in which the station apparatus is not able to perform a reception operation in the response frame to the medium reserving frame transmitted by the access point apparatus. Here, the information of the connection can be a channel number shared with the access point apparatus. In addition, the access point apparatus can broadcast information about the connection maintained by the apparatus itself using a beacon frame or the like, and in this case, numbers (IDs) may be given to multiple connections maintained by the apparatus itself. The station apparatus can treat the numbers as information of connections.

In a case that the access point apparatus transmits a frame in the connection 10-2, the access point apparatus may perform carrier sensing including a random back-off operation, and then transmit a frame. In this case, frame transmission start timings of each of a frame transmitted in the connection 10-1 and a frame transmitted in the connection 10-2 after the first response frame is received do not match in the connection 10-1 and the connection 10-2. However, it is preferable for the access point apparatus to match the frame ends of the frames transmitted in the connections 10-1 and 10-2. Alternatively, the access point apparatus can set the frame end of the frame transmitted in the connection 10-2 to be at an earlier timing than the frame end of the frame transmitted in the connection 10-1. Furthermore, the access point apparatus can transmit a frame (first opening frame) for releasing the radio medium reserved by using the RTS frame transmitted in advance in the connection 10-2 before performing carrier sensing in the connection 10-2.

Further, in a case that the access point apparatus is performing carrier sensing to transmit a medium reserving frame and transmits the frame in the connection 10-2, the access point apparatus does not need to perform carrier sensing.

The information about multiple connections described in the response frame by the station apparatus can further describe multiple pieces of information in each connection. For example, in a case that the connection 10-2 is a channel of 80 MHz bandwidth, the station apparatus may further split the 80 MHz channel into four bands, each having 20 MHz, and describe, in the response frame, the information indicating the state of the radio medium, such as a state of a NAV or a state of reception power previously indicated for each of the bands, and notify the access point apparatus of the information. This means that there are multiple fields in which the information indicating the state of the radio medium is described in the response frame transmitted by the station apparatus, and the multiple fields include a field in which information about each connection is described and a field in which information indicating a state of a radio medium of each of multiple channels in a case that each connection has multiple channels.

Under the control described above, the access point apparatus and the station apparatus can efficiently exchange frames using multiple connections in an environment dense with many access point apparatuses and station apparatuses, and thus system efficiency can be improved.

### 2. Second Embodiment

The access point apparatus and the station apparatus constituting the present embodiment have the same configuration as that of the first embodiment.

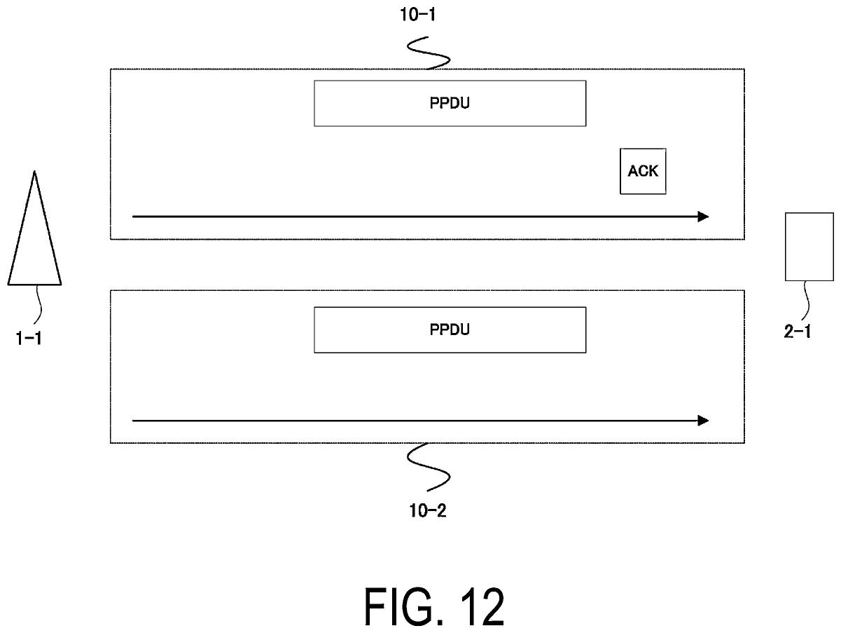

FIG. 12 is a schematic diagram illustrating another state of communication according to the present embodiment. In the present embodiment, the access point apparatus configures a connection for requesting a response frame to the station apparatus in accordance with a state of a radio medium of multiple connections.

A case that the access point apparatus determines that, whereas the radio medium is in an idle state in the connection 10-1, the radio medium is in a busy state due to an OBSS frame in the connection 10-2 will be considered. Normally, in the case that the radio medium is determined to be in a busy state, the communication apparatus is not able to transmit a frame using the radio medium. However, in a case that a predetermined criterion is satisfied, the communication apparatus can transmit a frame in a case that the radio medium is determined to be in a busy state based on the OBSS frame.

Thus, while the access point apparatus transmits frames in each of the connection 10-1 and the connection 10-2, it is not expected that a response frame is transmitted from the station apparatus in the connection 10-2. In a case that the frame transmitted by the access point apparatus in the connection 10-2 is a frame soliciting a response frame, the access point apparatus can indicate to the station apparatus to transmit the response frame in the connection 10-1, or include the information including the response frame in a frame to be transmitted in the connection 10-1.

The access point apparatus has recognized that the radio medium is in a busy state in the connection 10-2 based on the OBSS frame, and thus the access point apparatus can perform frame transmission according to a criterion for the connection 10-2 in which frame transmission can be performed. On the other hand, correct reception of the frame transmitted by the station apparatus in the connection 10-2 is not assured for the access point apparatus. Thus, the access point apparatus can notify the station apparatus to transmit, in the connection 10-1, a response frame solicited by the frame transmitted by the access point apparatus in the connection 10-2.

Further, in a case that the access point apparatus transmits a frame using multiple connections, the radio medium needs to be in an idle state in at least one connection. In other words, while it is determined that the radio medium is in a busy state in all of the multiple connections in which the access point apparatus intends to perform frame transmission based on any of the OBSS frame or a frame belonging to a BSS managed by the access point apparatus, frame transmission cannot be performed even in a case that the multiple connections include a connection in which the radio medium is determined to be in a busy state based on the OBSS frame. In other words, in a case that the reception of the response frame transmitted from the station apparatus is assured in at least one connection among the multiple connections in which frames are transmitted, the access point apparatus can transmit frames in a connection in which the radio medium is determined to be in a busy state due to the OBSS frame.

### 3. Third Embodiment

The access point apparatus and the station apparatus constituting the present embodiment have the same configuration as that of the first embodiment.

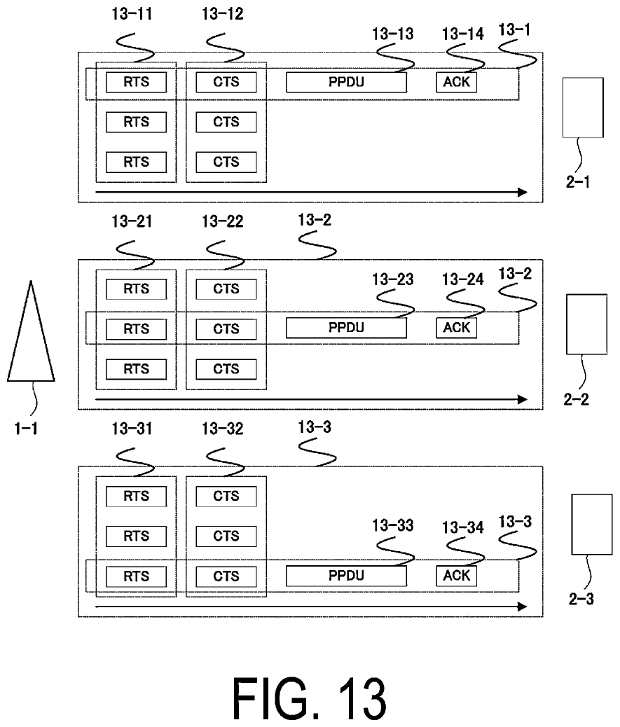

FIG. 13 is a schematic diagram illustrating another state of communication according to the present embodiment. In the present embodiment, a station apparatus 2-1, a station apparatus 2-2, and a station apparatus 2-3 are connected to an access point apparatus 1-1. The access point apparatus can perform frame exchange with each station apparatus using three connections maintained by the apparatus itself.

The access point apparatus 1-1 transmits a medium reserving frame that reserves a radio medium of each connection for a certain period of time for in the three connections maintained by the apparatus itself. The access point apparatus expects the medium reserving frame to be demodulated at the station apparatus 2-1, the station apparatus 2-2, and the station apparatus 2-3, and thus the access point apparatus can describe information indicating the station apparatus 2-1, the station apparatus 2-2, and the station apparatus 2-3 in the medium reserving frame. In addition, the access point apparatus expects that the medium reserving frame will be demodulated in all of the station apparatuses connected to the BSS managed by the access point apparatus, and thus information associated with the BSS can be described therein. Further, it is needless to say that the access point apparatus performs carrier sensing in each of the connections, prior to transmitting the medium reserving frame, and the example in FIG. 13 illustrates a case that the access point apparatus can transmit the medium reserving frame in all of the three connections being maintained.

The medium reserving frame transmitted by the access point apparatus 1-1 is not limited to anything. For example, the access point apparatus 1-1 can transmit an RTS frame or a MU-RTS frame as a medium reserving frame. For example, the access point apparatus can transmit to a station apparatus a trigger frame for soliciting a frame as a medium reserving frame, the station apparatus being expected to demodulate the medium reserving frame.

The access point apparatus according to the present embodiment can describe information indicating a station apparatus that can preferentially use each connection in the medium reserving frame transmitted in multiple connections. In the example illustrated in FIG. 13, since a connection 13-1 is preferentially (or exclusively) used by the station apparatus 2-1, the access point apparatus can describe information indicating that the station 2-1 can preferentially use the connection 13-1 at least in a medium reserving frame transmitted in the connection 13-1 of a medium reserving frame 13-11. Although the information described in the medium reserving frame 13-11 by the access point apparatus is not limited to any information, for example, a predetermined field (a preferential use field, a connection designation field, or the like) may be included in the medium reserving frame 13-11, and the access point apparatus may describe the information indicating the station apparatus 2-1 (e.g., AID or Partial AID) in the predetermined field. Similarly, in the example of FIG. 13, a connection 13-2 can be preferentially used by the station apparatus 2-2, and a connection 13-3 can be preferentially used by the station apparatus 2-3.

In a case that the station apparatus that has received a medium reserving frame performs carrier sensing in the connection in which the medium reserving frame is received among multiple connections and the connection is determined to be in an idle state, the station apparatus transmits a response frame with respect to the medium reserving frame. Here, the station apparatus transmits the response frame in all connections that can be determined to be in an idle state. That is, in the example illustrated in FIG. 13, the station apparatus 2-1 can preferentially use the connection 13-1, and can transmit the response frame in all of the connections.

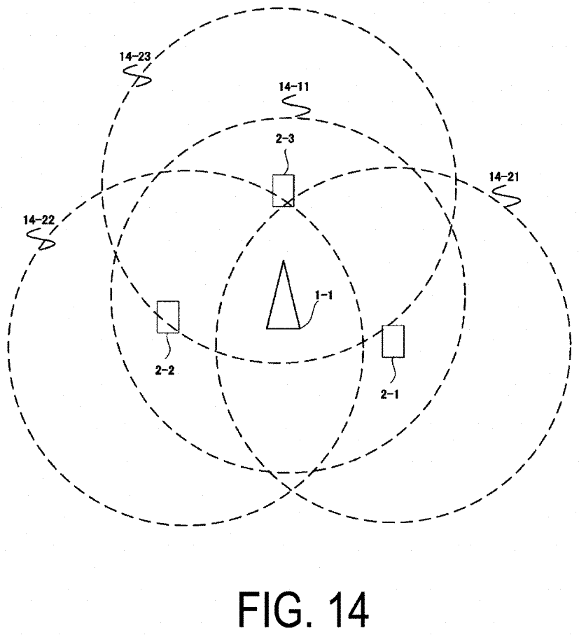

Here, since the access point apparatus and the multiple station apparatuses exchange the medium reserving frame and the response frame, the radio medium of multiple connections can be widely reserved in the surroundings of the access point apparatus and the multiple station apparatuses. FIG. 14 is a schematic diagram illustrating another state of communication according to the present embodiment. For simplicity, the connection 13-1 is focused. While the access point apparatus 1-1 can recognize the status of the radio medium in a range 14-11 by performing carrier sensing, it is not able to recognize the entire range 14-21, range 14-22, and range 14-23 that the station apparatuses 2 could ascertain the radio medium by performing carrier sensing. Thus, by exchanging the medium reserving frame and the response frame, the access point apparatus 1-1 and the station apparatuses 2 can share the carrier sensing statuses of each other. Thus, the medium reserving frame and the response frame enable the radio medium to be reserved in a predetermined period of time.

In the way of thinking of the related art, the frame exchange of a medium reserving frame and a response frame is performed by communication apparatuses that perform data frame exchange followed by the frame exchange. However, in an environment dense with a huge number of communication apparatuses, interference power caused by the frame exchange performed in other BSS is not negligible. According to the method of the present embodiment, the apparatuses that actually perform data frame exchange in the connection 13-1 are the access point apparatus 1-1 and the station apparatus 2-1 in the example of FIG. 14. However, the station apparatus 2-2 and the station apparatus 2-3 also perform frame exchange of the medium reserving frame and the response frame with the access point apparatus 1-1 in the connection 13-1, and thus the radio medium can be reserved in a wider range in the connection 13-1.

In a case that, among multiple connections in which the medium reserving frame has been received, a connection that allows prioritized use by the station apparatus 2 according to the present embodiment is in a busy state, and another connection in which the radio medium is determined to be in an idle state is present, the station apparatus 2 can transmit a response frame in the other connection in which the radio medium is determined to be in an idle state.

In addition, in the method of the related art, after a medium reserving frame and a response frame are exchanged, a communication apparatus that has transmitted the medium reserving frame is capable of transmitting frames. In the present embodiment, after a medium reserving frame and a response frame are exchanged, the communication apparatus that has transmitted the response frame can transmit frames.

The response frame transmitted by the station apparatus 2 in each connection can have information included in the frame shared with the access point apparatus 1-1. This means that the shared response frame transmitted from each station apparatus 2 is received by the access point apparatus 1-1 at the same time, and thus the access point apparatus 1-1 cannot identify the station apparatus 2 that could actually transmit the response frame. However, since the medium reserving frame includes the information indicating the station apparatus 2 that can preferentially (exclusively) use each connection, the access point apparatus 1-1 can recognize in advance which station apparatus 2 transmits frames in each connection after the response frame is received.

However, this does not mean that each station apparatus 2 is certainly not able to transmit even a data frame in a case that the access point apparatus 1-1 fails to receive one response frame after transmitting the medium reserving frame. In that case, the access point apparatus 1-1 can transmit a medium reserving frame again, or can transmit a medium releasing frame (e.g., contention free period end frame or CF-end frame) for releasing the radio medium that has been reserved due to the medium reserving frame for a predetermined period of time.

Referring back to FIG. 13, each station apparatus that has transmitted the response frame in the multiple connections can transmit frames in a connection that the medium reserving frame has notified of the station apparatus that it can be preferentially used by the apparatus among the multiple connections in which the response frame has been transmitted. According to the example of FIG. 13, the station apparatus 2-1 has the priority to use the connection. In the connection 13-1, a data frame 13-13 can be transmitted after a response frame 13-12 is transmitted. At this moment, the station apparatus 2-1 has already performed the frame exchange for the medium reserving frame and the response frame with the access point apparatus, and thus the data frame 13-13 can be transmitted without performing carrier sensing. Thus, after transmitting the response frame, it is desirable for the station apparatus 2-1 to wait for an SIFS that is an IFS to be used when transmitting a frame having the highest priority and perform frame transmission. Further, whether the station apparatus performs carrier sensing after transmitting the response frame may be indicated by the access point apparatus through the medium reserving frame.

The communication apparatuses can exchange the medium reserving frame and the response frame in one connection. The access point apparatus can split frequency resources of a predetermined bandwidth into multiple pieces. For example, the access point apparatus can split a predetermined bandwidth into resource units (RUs) including multiple subcarriers (tones). The access point apparatus can transmit medium reserving frames in each RU. In addition, the access point apparatus can describe information indicating a station apparatus that can preferentially use each RU in the medium reserving frame transmitted in the RU. The station apparatus that has received the medium reserving frame in each RU performs carrier sensing regardless of whether the station apparatus can preferentially use each RU, and transmits a response frame in a case that the connection is determined to be in an idle state. Here, the carrier sensing may be performed in units of RUs, or in units of predetermined bandwidths configured by the access point apparatus. Furthermore, the response frame transmitted by the station apparatus may also be transmitted in units of RUs, or in units of predetermined bandwidths configured by the access point apparatus. Of course, the access point apparatus may also transmit the medium reserving frame in units of RUs, or in units of predetermined bandwidths.

The station apparatus that has transmitted the response frame can transmit a data frame in the RU that can be preferentially used by the apparatus itself after transmitting the response frame in radio resources including the RU. At this moment, the PHY header included in the data frame may be transmitted in the bandwidth of the RU, or in a predetermined bandwidth configured by the access point apparatus 1-1.

According to the method described above, the access point apparatus and the station apparatuses can reserve the radio medium in a wider range when performing frame exchange in multiple connections, and thus the communication quality can be improved even in a dense environment.

### 4. Matters Common for all Embodiments

Although the communication apparatuses according to an aspect of the present invention can perform communication in a frequency band (frequency spectrum) that is a so-called unlicensed band that does not require permission to use from a country or a region, available frequency bands are not limited thereto. Although permission to use a specific service is given from a country or a region, the communication apparatuses according to an aspect of the present invention can exhibit the effect that can be brought by the purpose of preventing interference between frequencies, and the like, in a frequency band called a white band that is not actually used (e.g., a frequency band that is allocated for television broadcasting but is not used depending on regions), or a shared spectrum (shared frequency band) that is expected to be shared by multiple service providers, for example.

In addition, a communication standard to be applied to the communication apparatuses according to an aspect of the present invention is not limited. For example, in a case that a communication standard (e.g., a communication standard approved as IMT-Advanced or a communication standard approved as IMT-2020 by the ITU-R) mostly applied to a frequency band for which permission to use should be acquired from a country or a region, that is called a licensed band, is introduced into an unlicensed band, the same effects can be exhibited also in the communication standard.

A program operated in the wireless communication apparatuses according to an aspect of the present invention is a program (a program for causing a computer to function) for controlling a CPU or the like to implement the functions of the aforementioned embodiments according to an aspect of the present invention. In addition, information handled by these apparatuses is temporarily accumulated in a RAM at the time of processing, is then stored in various types of ROMs and HDDs, and is read by the CPU as necessary to be corrected and written. A semiconductor medium (e.g., a ROM, a non-volatile memory card, etc.), an optical recording medium (e.g., a DVD, an MO, an MD, a CD, a BD, etc.), a magnetic recording medium (e.g., a magnetic tape, a flexible disk, etc.), and the like can be examples of recording media for storing programs. In addition to implementing the functions of the aforementioned embodiments by performing loaded programs, the functions of the present invention are implemented in processing performed in cooperation of an operating system, other application programs, and the like based on instructions of those programs.

In a case of delivering these programs to market, the programs can be stored and distributed in a portable recording medium, or transferred to a server computer connected via a network such as the Internet. In this case, storage apparatuses of the server computer are also included in an aspect of the present invention. In addition, a part or an entirety of the communication apparatuses in the aforementioned embodiments may be implemented as an LSI that is typically an integrated circuit. The functional blocks of the communication apparatuses may be individually implemented as chips or may be partially or completely integrated into a chip. In a case that the functional blocks are made as integrated circuits, an integrated circuit controller for controlling them is added.

In addition, the circuit integration technique is not limited to LSI, and may be realized as dedicated circuits or a multi-purpose processor. Moreover, in a case that a circuit integration technology that substitutes an LSI appears with the advance of the semiconductor technology, it is also possible to use an integrated circuit based on the technology.

Further, the invention of the present application is not limited to the above-described embodiments. The wireless communication apparatus according to the invention of the present application is not limited to the application in the mobile station apparatus, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

Although the embodiments of the invention have been described in detail above with reference to the drawings, a specific configuration is not limited to the embodiments, and designs and the like that do not depart from the essential spirit of the invention also fall within the claims.

### INDUSTRIAL APPLICABILITY

An aspect of the present invention can be preferably used in an access point apparatus, a station apparatus, and a communication method.

### REFERENCE SIGNS LIST

1-1, 1-2 Access point apparatus
2-1 to 8 Station apparatus
3-1, 3-2 Control range
10001-1 Higher layer unit
10002-1 Autonomous distributed controller
10002a-1 CCA unit
10002b-1 Backoff unit
10002c-1 Transmission determination unit
10003-1 Transmitter
10003a-1 Physical layer frame generator
10003b-1 Wireless transmitter
10004-1 Receiver
10004a-1 Wireless receiver
10004b-1 Signal demodulator
10005-1 Antenna

1-7. (canceled)

8: station apparatus configured to communicate with an access point apparatus, the station apparatus comprising:
a receiver configured to receive, through a wireless link, a trigger frame transmitted from the access point apparatus to the station apparatus; and
a transmitter configured to transmit, in response to the trigger frame, a response frame to the access point apparatus through the wireless link, wherein
the transmitter is configured to transmit, through the wireless link, a data frame after transmitting the response frame to the access point apparatus.

9: The station apparatus of claim 8, wherein
the trigger frame includes a predetermined field in which information causing the station apparatus to use the wireless link is described.

10: The station apparatus of claim 9, wherein
the receiver is configured to, based on a predetermined condition, determine whether or not to update a network allocation vector configured based on the information described in the trigger frame.

11: The station apparatus of claim 10, wherein
the predetermined condition includes a condition of receiving a contention free period end frame transmitted from the access point apparatus.

12: An access point apparatus configured to communicate with a station apparatus, the access point apparatus comprising:
a transmitter configured to transmit a trigger frame to the station apparatus through a wireless link; and
a transmitter configured to receive, in response to the trigger frame, a response frame transmitted from the station apparatus to the access point apparatus, through the wireless link, wherein
the trigger frame includes a predetermined field in which information causing the station apparatus to use the wireless link is described.

13: A communication method for a station apparatus configured to communicate with an access point apparatus, the communication method comprising:
receiving, through a wireless link, a trigger frame transmitted from the access point apparatus to the station apparatus;
transmitting, in response to the trigger frame, a response frame to the access point apparatus through the wireless link; and
transmitting, through the wireless link, a data frame after transmitting the response frame to the access point apparatus.
